(19) United States
(12) Patent Application Publication
(10) Pub. No.: US 2006/0082527 A1
(43) Pub. Date: Apr. 20, 2006

(54) Display device

(75) Inventor: Takashi Ogawa, Gifu (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/236,848

(22) Filed: Sep. 28, 2005

(30) Foreign Application Priority Data
Sep. 30, 2004 (JP) 2004-287115

(51) Int. Cl. G09G 3/32

(52) U.S. Cl. 345/82

(57) ABSTRACT

The invention is directed to a display device that can display a grayscale image by a digital drive method, without a frame memory and heat generation of the display device caused by a drive current. Without dividing one field period into a scan period and a light emission period as in an organic EL display device using a conventional digital drive method, image data from a data line are written in pixels in each of lines, and ramp voltages generated for each of the lines and image data voltages are compared with each other, and light emission display is performed based on the comparison result. This can provide a display device that can display a grayscale image by a digital drive method without the frame memory. Furthermore, an electric current to be supplied to the organic EL elements is reduced, so that the heat generation of the display device can be prevented to enhance reliability.

### CROSS-REFERENCE OF THE INVENTION

This invention is based on Japanese Patent Application No. 2004-287115, the content of which is incorporated by reference in its entirety.

### BACKGROUND OF THE INVENTION

1. Field of the Invention

The invention relates to a display device, particularly, a display device that can display a grayscale image corresponding to image data.

2. Description of the Related Art

In recent years, organic electroluminescent (hereafter, referred to as EL) display devices with organic EL elements are receiving attention as display devices replacing a CRT and an LCD. Particularly, research and development are pursued for active matrix type organic EL display devices having thin film transistors (hereafter, referred to as TFTs) as driving transistors for supplying a drive current to the organic EL elements of pixels.

An analog drive method and a digital drive method have been known as a drive method for displaying a grayscale image in the active matrix type organic EL display device. In the organic EL display device using the analog drive method, an electric current is supplied to the organic EL element by an amount corresponding to data voltage to light the organic EL element with luminance corresponding to the data voltage. On the other hand, in the organic EL display device using the digital drive method, a pulse current having a duty ratio corresponding to data voltage is supplied to the organic EL element, so that a grayscale image can be displayed.

Hereafter, the organic EL display device using the digital drive method will be described with reference to figures. This organic EL display device using the digital drive method is configured by connecting a scan driver 3 and a data driver 4 to a display panel 5 formed of a plurality of pixels arrayed in a matrix, as shown in FIG. 7. An image signal supplied from an image source such as a TV is supplied to an image signal processing circuit 6 and goes under signal processing necessary for image display, and an image signal of three primary colors R, G and B obtained by the signal processing is supplied to the data driver 4 of an organic EL display 2.

Furthermore, a horizontal synchronization signal Hsync and a vertical synchronization signal Vsync obtained from the image signal processing circuit 6 are supplied to a timing signal generating circuit 7, and a timing signal obtained in the circuit 7 is supplied to the scan driver 3 and the data driver 4. The timing signal obtained from the timing signal generating circuit 7 is further supplied to a ramp voltage generating circuit 8, so that a ramp voltage to be used for driving the organic EL display 2 as described below is formed, and the ramp voltage is supplied to each of the pixels of the display panel 5. It is noted that each of the circuits, the drivers, and the organic EL display shown in FIG. 7 is connected with a power supply circuit (not shown).

The display panel 5 is formed of pixels 51 arrayed in a matrix, each of which has a circuit structure shown in FIG. 8. Each of the pixels 51 is formed of an organic EL element 50 formed of an organic layer, a driving transistor TR2 turning on or off electricity to the organic EL element 50 in response to an on or off control signal inputted to its gate, a write transistor TR1 which turns on when its gate is applied with a scan voltage from the scan driver, a capacitor element C for storing data which is applied with a data voltage from the data driver when the write transistor TR1 turns on, and a comparator 9 having a positive input terminal and a negative input terminal. The negative input terminal receives an output voltage of the capacitor element C, and the positive input terminal receives a ramp voltage supplied from the ramp voltage generating circuit 8 so that the comparator can compare the two input signals. An output signal of the comparator 9 is supplied to the gate of the driving transistor TR2.

A current supply line 54 is connected with a source of the driving transistor TR2, and a voltage PVDD is applied to this current supply line 54. A drain of the driving transistor TR2 is connected with an anode of the organic EL element 50, and a voltage CV is applied to a cathode of the organic EL element 50.

The data driver is connected with one electrode (e.g. a source) of the write transistor TR1, and another electrode (e.g. a drain) of the write transistor TR1 is connected with one terminal of the capacitor element C and an inverting input terminal of the comparator 9. An output terminal of the ramp voltage generating circuit 8 is connected with a non-inverting input terminal of the comparator 9.

In the described organic EL display 2, as shown in FIG. 9A, one field period is divided by time into a scan period in the first part and a light emission period in the latter part. A scan voltage from the scan driver is applied to the write transistors TR1 respectively forming the pixels in each of horizontal lines in the scan period, so that the write transistors TR1 turn on. Therefore, the image data voltage from the data driver is applied to the capacitor elements C, and stored therein as electric charge. As a result, image data for one field are set in all the pixels forming the organic EL display 2.

Furthermore, in each of one field periods, the ramp voltage generating circuit 8 keeps high voltage values in the scan period of the first part, and generates ramp voltages which linearly change from low voltage values to high voltage values in the light emission period of the latter part, as shown in FIG. 9B. In the scan period of the first part, by applying the high voltage from the ramp voltage generating circuit 8 to the non-inverting input terminal of the comparator 9, the output of the comparator 9 keeps high regardless of the input voltage to the inverting input terminal as shown in FIG. 9C.

Furthermore, in the light emission period of the latter part, a ramp voltage from the ramp voltage generating circuit 8 is applied to the non-inverting input terminal of the comparator 9 and an output voltage (data voltage) of the capacitor element C is applied to the inverting input terminal of the comparator 9, so that the output of the comparator 9 forms two low and high values corresponding to the result of comparison of both the voltages, as shown in FIG. 9C. That is, the output of the comparator 9 is low in the period when the ramp voltage is lower than the image data voltage, and the output of the comparator 9 is high in the period when the ramp voltage is higher than the image data voltage. The period when the output of the comparator is low is proportional to the amount of the data voltage.

In this manner, the output of the comparator 9 becomes low only in the period proportional to the amount of the data voltage, so that the driving transistor TR2 turns on and the electricity to the organic EL element 50 turns on only in this period. As a result, the organic EL element 50 in each of the pixels 51 forming the display panel 5 emits light only in the period proportional to the amount of the image data voltage applied to each of the pixels 51 in one field period, so that the grayscale image display can be realized.

As described above, in this organic EL display device, since the grayscale image display can be performed only by performing one scanning in one field period, high speed scanning is not necessary and a false contour does not occur. Furthermore, since this organic EL display device uses the digital drive method, the device is hardly affected by variation in characteristics of the driving transistors TR2, and power consumption can be reduced by reduction of the power supply voltage. The relevant technology is disclosed in the Japanese Patent Application Publication No. 2003-241711.

However, in the described organic EL display device using the digital drive method, since the first part of the one field period is set as the scan period, the image data for one field are written in all the pixels in the scan period, and the latter part of the one field period is set as the light emission period, it is necessary to provide a field memory for storing the image data for one field.

Furthermore, since the light emission period is shorter than the one field period in this method, for obtaining the same luminance as in the organic EL display device using the analog drive method, a drive current (a current to be flowed to the organic EL element 50 through the driving transistor TR2) increases in the light emission period, and thus heat generation of the display panel 5 increases. The increased heat generation of the display panel 5 degrades the emission characteristics of the organic EL element 50, causing display failures.

### SUMMARY OF THE INVENTION

The invention provides a display device that includes a plurality of pixels arranged in a matrix form having rows and columns, a scan driver supplying scan signals to the pixels, a data driver supplying image data signals to the pixels, and a ramp voltage generating circuit comprising a plurality of ramp voltage generating units. Each of the ramp voltage generating units supplies a ramp voltage to a corresponding row of the pixels in response to the supplying of a scan signal to the corresponding row of the pixels.

### BRIEF DESCRIPTION OF THE DRAWINGS

FIG. 1 is a view of an entire structure of an organic EL display device of an embodiment of the invention.

FIG. 2 is a block diagram showing a pixel region of the organic EL display device of the embodiment of the invention.

FIG. 3 is an operation waveform diagram of the organic EL display device of the embodiment of the invention.

FIG. 4 is a circuit diagram of a ramp voltage generating circuit of the organic EL display device of the embodiment of the invention.

FIGS. 5 and 6 are operation waveform diagrams of the ramp voltage generating circuit of the organic EL display device of the embodiment of the invention.

FIG. 7 is a view of an entire structure of an organic EL display device of a conventional art.

FIG. 8 is an equivalent circuit diagram of one of pixels of the organic EL display device of the conventional art.

FIGS. 9A, 9B, and 9C are views for explaining the operation of the organic EL display device of the conventional art.

### DETAILED DESCRIPTION OF THE INVENTION

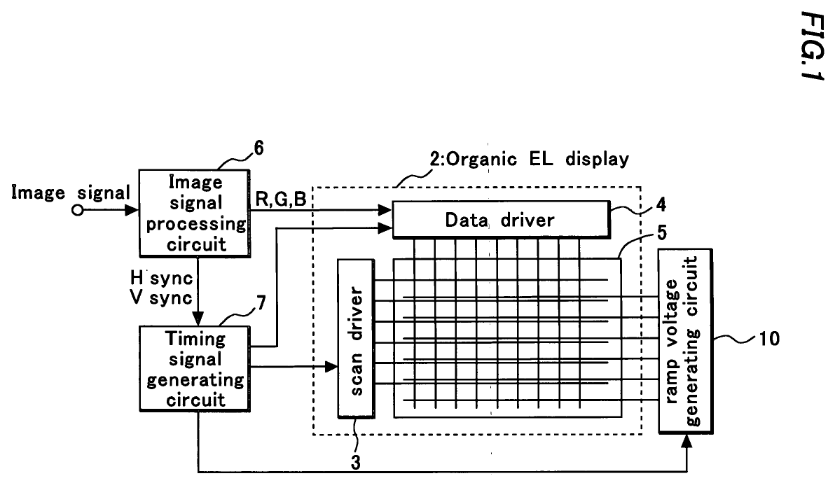

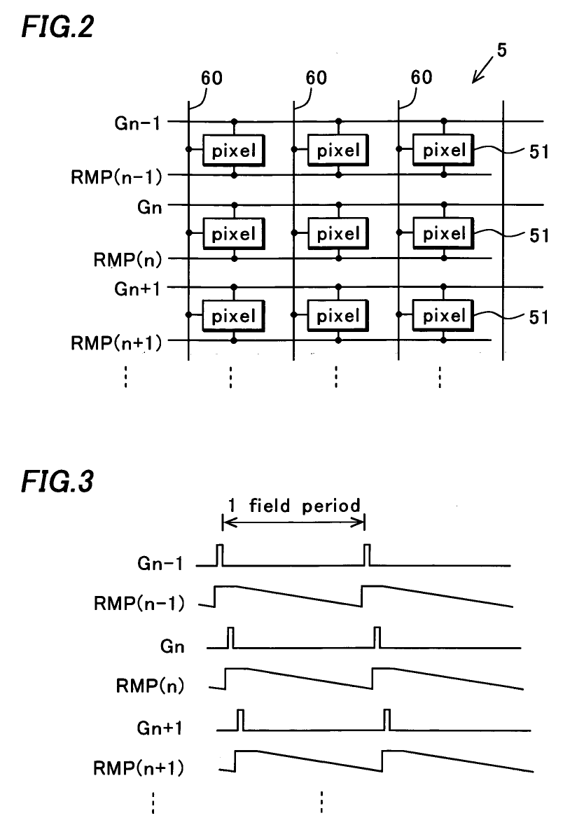

An organic EL display device of an embodiment of the invention will be described with reference to figures. FIG. 1 is a block diagram showing an entire structure of the organic EL display device. FIG. 2 is a block diagram showing a pixel region of a display panel 5. FIG. 3 is an operation waveform diagram of the organic EL display device, showing a relation between scan pulse signals Gn−1, Gn, and Gn+1 outputted from a scan driver 3 of FIG. 1 to pixels in each of lines and ramp voltages RMP(n−1), RMP(n), and RMP(n+1) outputted from a ramp voltage generating circuit 10 of FIG. 1 to the pixels in each of the lines.

This organic EL display device displays a grayscale image not by dividing one field period into a scan period and a light emission period as in an organic EL display device using a conventional digital drive method, but by writing image data in each of lines, generating a ramp voltage synchronized with a scan pulse signal in each of the lines, comparing this ramp voltage and the image data voltage by a comparator, and driving a light emissive element based on an output of the comparator.

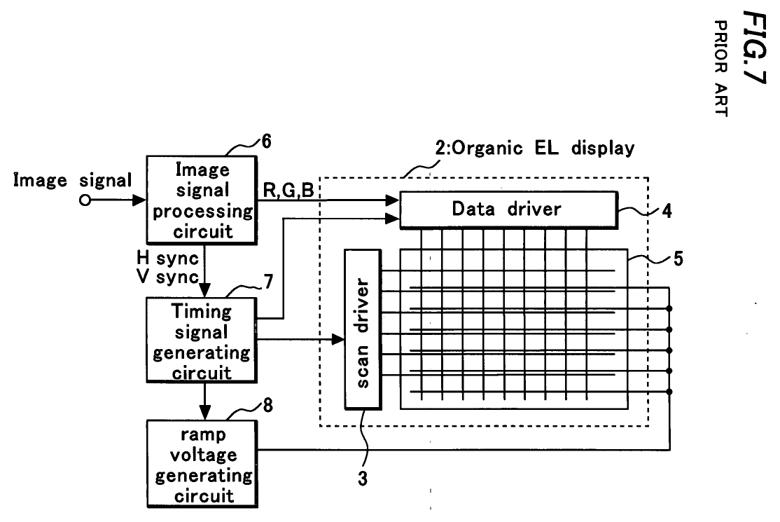

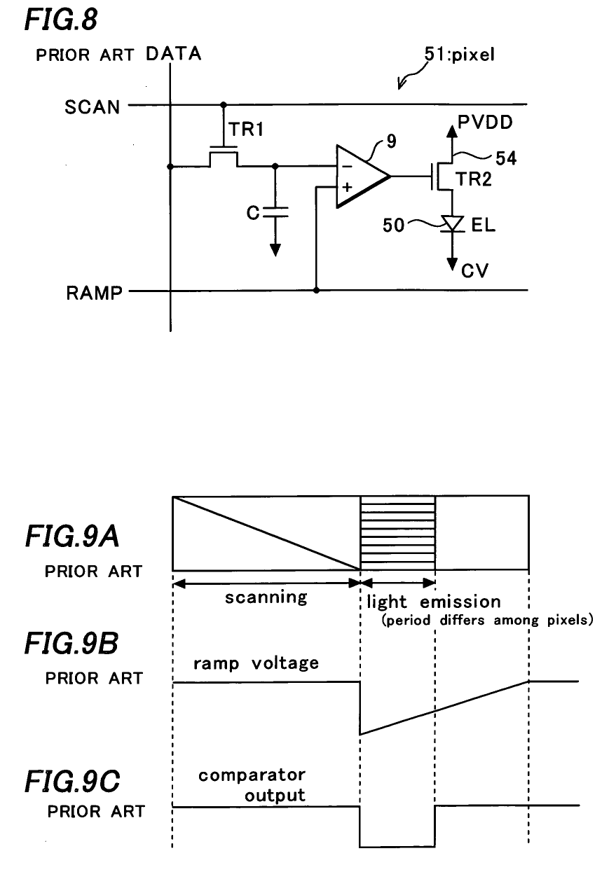

In the display panel 5, as shown in FIG. 2, pixels 51 shown in FIG. 7 are arrayed in a matrix of rows and columns, and a scan signal Gn−1 is commonly supplied to each of the pixels 51 in a (n−1)-th line. The scan pulse signal Gn−1 is applied to gates of write transistors TR1 of the pixels 51. Furthermore, a ramp voltage RMP(n−1) is generated at the same time as the scan pulse signal Gn−1 is generated. The generated ramp voltage RMP(n−1) is commonly supplied to the pixels 51 in the (n−1)-th line, and applied to non-inverting input terminals of the comparators 9.

Similarly, a scan pulse signal Gn is commonly supplied to pixels 51 in a n-th line.

Furthermore, a ramp voltage RMP(n) generated simultaneously with the scan pulse signal Gn is commonly supplied to the pixels 51 in the n-th line. The same operation is performed to other lines, too.

In the operation of this organic EL display device, as shown in FIG. 3, when the scan pulse signal Gn−1 becomes high, the pixels 51 in the (n−1)-th line are selected in response to this, and image data from a data driver 4 are written in the pixels 51 through a data line 60 connected to these pixels 51. The write transistors TR1 of the pixels 51 turn on, and the image data from the data driver 4 are stored in storage capacitor elements C through these write transistors TR1.

On the other hand, in response to the generation of the scan pulse signal Gn−1, the ramp voltage RMP(n−1) of a predetermined voltage, for example, declining from 8V to 0V, is generated. This ramp voltage RMP(n−1) and the image data voltage stored by the storage capacitor element C are compared by each of the comparators 9. The output of the comparator 9 forms two low and high values corresponding to the comparison result.

In detail, in the period when the ramp voltage RMP(n−1) is higher than the image data 10 voltage, the output of the comparator 9 becomes high, and in the period when the ramp voltage RMP(n−1) is lower than the image data voltage, the output of the comparator 9 becomes low. At this time, the period when the output of the comparator 9 is low is proportional to the amount of the data voltage. In this manner, the output of the comparator 9 becomes low only in the period proportional to the amount of the data voltage, so that the driving transistor TR2 turns on and the electricity to the organic EL element 50 turns on only in that period.

Next, when the scan pulse signal Gn becomes high, the pixels 51 in the n-th line are selected in response to this and image data from the data driver 4 are written in the pixels 51 through a data line 60 connected to these pixels 51. Similarly, the ramp voltage RMP(n) is generated in response to the generation of the scan pulse signal Gn. In this manner, writing of the image data and light emission of the organic EL element 50 are performed simultaneously in each of the lines, and as a result of this, the organic EL elements 50 of the pixels 51 forming the display panel 5 emit light only in the period proportional to the amount of the image data voltage supplied to the pixels 51 in one field period. The grayscale image display is thus realized.

In this embodiment, without dividing one field period into the scan period and the light emission period as in the organic EL display device using the conventional digital drive method, the image data are written, the ramp voltage and the image data voltage are compared with each other, and the light emission display is performed based on the comparison result, in each of the lines. Therefore, the grayscale image can be displayed, and a frame memory is not needed since the image data for one field need not be stored in advance. Furthermore, the entire one field period can be the light emission period, so that the drive current to be supplied to the organic EL elements 50 is reduced and heat generation of the display panel 5 can be prevented.

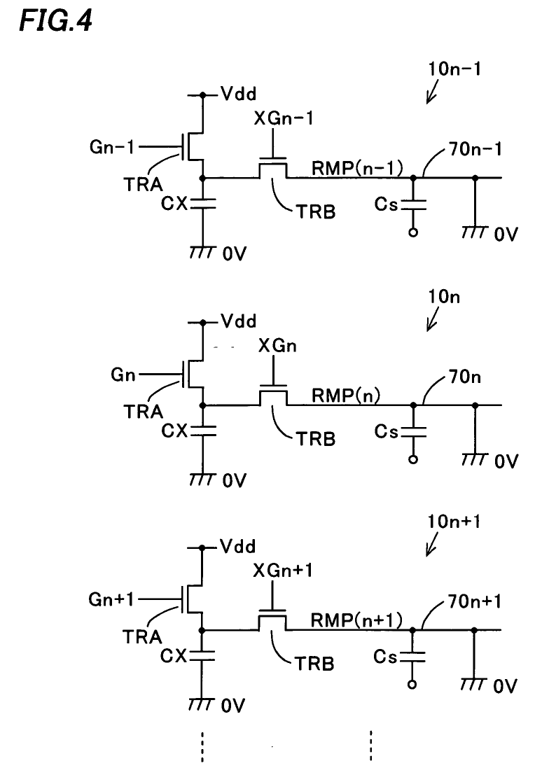

Next, a concrete structure of the ramp voltage generating circuit 10 will be described with reference to FIG. 4. This ramp voltage generating circuit 10 is formed of a plurality of ramp voltage generating units 10n−1, 10n, 10n+1, . . . corresponding to each of the lines, unlike the conventional ramp voltage generation circuit that has only one ramp voltage generation unit which supplies the common ramp voltage to all the comparators. For example, the ramp voltage generating unit 10n−1 has a charge transistor TRA which turns on with low impedance in response to the scan pulse signal Gn−1 from the scan driver 3 which is high and turns off in response to the signal Gn−1 which is low, a capacitor element CX which is rapidly charged up to the power supply voltage Vdd by the charge transistor TRA turning on in response to the scan pulse signal Gn−1, and a discharge transistor TRB which discharges the electric charge stored in the capacitor element CX to the ground voltage 0V through the ramp voltage output line 70n−1. The ramp voltage output line 70n−1 is connected with the non-inverting input terminals (+) of the comparators 9 of the pixels 51 connected with the (n−1)-th line.

One terminal of the ramp voltage output line 70n−1 is biased to 0V by being connected with the voltage lower than the power supply voltage Vdd (e.g. 8V), for example, the ground voltage 0V. The gate of the discharge transistor TRB is applied with the voltage signal XGn−1 which is the same as or slightly higher than the threshold voltage of the discharge transistor TRB so that the discharge transistor TRB turns on with high impedance. The other ramp voltage generating units 10n, 10n+1, . . . have the same circuit structure as described above.

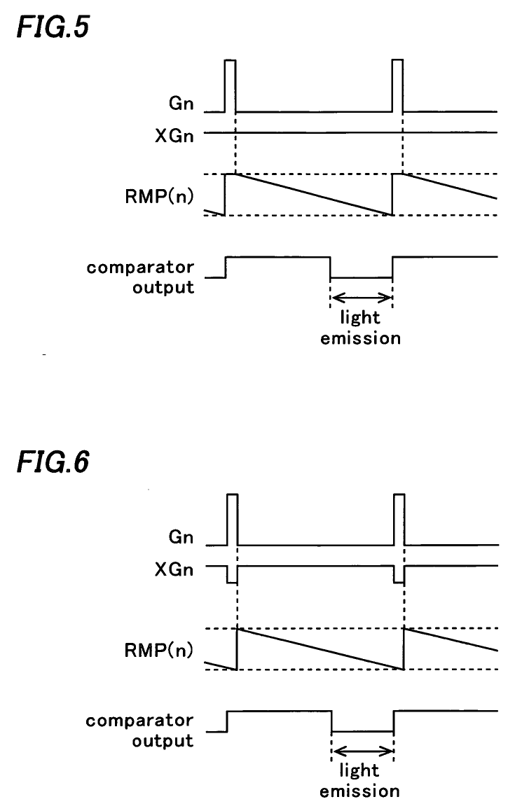

The operation of this ramp voltage generating circuit 10 will be described with reference to FIG. 5, taking the n-th ramp voltage generating unit 10n for example. When the scan pulse signal Gn becomes high, the charge transistor TRA turns on with low impedance, and the terminal of the capacitor element CX connected with the charge transistor TRA is rapidly charged up to the power supply voltage Vdd. Actually, voltage loss occurs by the threshold voltage of the charge transistor TRA, so that the charge voltage of the capacitor element CX is slightly lower than Vdd. Accordingly, the ramp voltage RMP(n) as the voltage of the ramp voltage output line 70n also rises rapidly to the power supply voltage Vdd through the discharge transistor TRB.

Then, when the charge transistor TRA turns off, the electric charge in the capacitor element CX is discharged to the ground voltage 0V through the discharge transistor TRB more slowly than when charged, and the electric charge stored in the parasitic capacitor element Cs connected with the ramp voltage output line 70n is also discharged to the ground voltage 0V, so that the waveform of the ramp voltage RMP(n) as shown in FIG. 5 can be obtained. Then, the ramp voltage RMP(n) reduces, and when the ramp voltage RMP(n) becomes lower than the image data voltage, the output of the comparator 9 becomes low as described above and the organic EL element 50 emits light.

The voltage signal XGn can be a pulse signal of an opposite phase to the scan pulse signal Gn−1, as shown in FIG. 6. In this case, the scan pulse signal Gn−1 and the charge transistor TRA respectively turn on and off complementarily. That is, when the scan pulse signal Gn−1 becomes high level, the charge transistor TRA turns on with low impedance. At the same time, the voltage signal XGn becomes low level, and the discharge transistor TRB turns off or turns on with high impedance. By this, the terminal of the capacitor element CX is rapidly charged up to the power supply voltage Vdd.

Then, when the scan-pulse signal Gn−1 becomes low level, the charge transistor TRA turns off. At the same time, the voltage signal XGn becomes high level, and the discharge transistor TRB turns on. Then, the electric charge stored in the capacitor element CX flows to the ramp voltage output line 70n through the discharge transistor TRB, and the ramp voltage output line 70n rapidly changes to the power supply voltage Vdd and then discharged to the ground voltage 0V. By this, the ramp voltage RMP(n) as shown in FIG. 6 can be obtained.

What is claimed is:

1. A display device comprising:
a plurality of pixels arranged in a matrix form comprising rows and columns;
a scan driver supplying scan signals to the pixels;
a data driver supplying image data signals to the pixels; and
a ramp voltage generating circuit comprising a plurality of ramp voltage generating units, each of the ramp voltage generating units supplying a ramp voltage to a corresponding row of the pixels in response to the supplying of a scan signal to the corresponding row of the pixels.

2. The display device of claim 1, wherein each of the pixels comprises a light emissive element emitting light, a write transistor turning on in response to a scan signal supplied by the scan driver, and a driver circuit that compares a image data signal supplied by the data driver through the write transistor with a corresponding ramp voltage and supplies an electric current to a corresponding light emissive element based on a result of the comparison.

3. The display device of claim 2, wherein the drive circuit comprises a storage circuit storing the image data signal, a comparator comparing the image data signal stored in the storage circuit with the corresponding ramp voltage, and a driving transistor that is connected with the light emissive element and turns on in response to an output of the comparator.

4. The display device of claim 1, wherein each of the ramp voltage generating units comprises a charge transistor turning on in response to the scan signal, a capacitor element charged up to a first voltage by the charge transistor, a ramp voltage output line connected with the capacitor element, and a bias circuit biasing the ramp voltage output line to a second voltage lower than the first voltage.

5. The display device of claim 4, wherein the first voltage is a power supply voltage, and the second voltage is a ground voltage.

6. The display device of claim 4, wherein the ramp voltage output line is connected with a discharge transistor discharging an electric charge stored in the capacitor element.

7. The display device of claim 6, wherein a gate of the discharge transistor is applied with a fixed voltage.

8. The display device of claim 6, wherein a gate voltage of the discharge transistor is controlled so that the discharge transistor and the charge transistor operate to switch complementarily.

9. The display device of claim 2, wherein the light emissive element comprises an organic electroluminescent element.
